(19) United States
(12) Patent Application Publication
(10) Pub. No.: US 2013/0122937 A1
(43) Pub. Date: May 16, 2013

(54) String Based Travel System and Methods Thereof

(71) Applicants: Charles A. Meyer, Irving, TX (US); Jason A. Snyder, Hoboken, NJ (US)

(72) Inventors: Charles A. Meyer, Irving, TX (US); Jason A. Snyder, Hoboken, NJ (US)

(73) Assignee: GOPOGO, LLC, Irving, TX (US)

(21) Appl. No.: 13/465,675

(22) Filed: May 7, 2012

Related U.S. Application Data
(60) Provisional application No. 61/483,373, filed on May 6, 2011.

(51) Int. Cl. H04W 4/02

(52) U.S. Cl. CPC H04W 4/028
USPC 455/456.3

(57) ABSTRACT

A string based travel generating system (TGS) of the present invention generates or suggests a string based upon one or more travel properties, such as, but not limited to, a current location, a direction of travel, a travel route, a travel plan, and/or a velocity of travel of a user. Each string includes at least two places and a relationship, with TGS using the travel properties to identify one or more places for the creation of a new string or a place that may be linked to an existing string. The relationship between the places of the string can include the type of travel underway and the anticipated destination. The travel and places may be physical or virtual, with an inference or extrapolation being developed that allows the travel generating system to determine suitable strings to suggest to a user or to allow for the generation of new strings.

### RELATED APPLICATION DATA

This application claims the benefit of priority of U.S. Provisional Patent Application Ser. No. 61/483,373, filed May 6, 2011, and titled “Geo-Location Based Playlist System and Method,” which is incorporated by reference herein in its entirety.

### FIELD OF THE INVENTION

The present invention generally relates to the field of web-based social interaction systems and methods. In particular, the present invention is directed to generation or association of a string of places for use in connection with real and virtual travel.

### BACKGROUND

The ability to share various pieces of information between individuals has increased dramatically in the digital age with the advent of various devices and computer programs that allow for near real-time knowledge about an individual's activities and whereabouts. While the information shared by authors using these computer-based social media websites may be distributed widely, the information is often fragmented and disjointed, robbing authors and receivers of the information of a more complete understanding of the experience the author is attempting to communicate. This fragmentation is even more problematic for a user that is traveling and who may lack local knowledge of the destination or locales en route.

Various websites adapted for use in connection with computers allow users to search and locate activities and places of interest. In some cases, a computer may be used in conjunction with a web-based mapping system having geolocation capabilities that may provide a display of activities (e.g., a movie) or places (e.g., a restaurant) of interest. Many known websites search for and locate activities of interest when a static query is initiated by the user. Recommendations from this static query may be selected based on geographic proximity to the location of the user.

### SUMMARY OF THE DISCLOSURE

In a first aspect, a travel generating system for use with a mobile device according to the present disclosure comprises: a computer-readable storage medium having executable computer program instructions including: a geolocation module configured to identify a travel property; a planning module configured to receive the travel property, wherein the planning module determines a travel plan for the mobile device based on the travel property, wherein the travel plan includes a string having at least two places related through relationship.

In another aspect, a string generating system for predicting a destination of a user while traveling and generating a travel plan related to the prediction is described, the string generating system comprises: a mobile device including a computer-readable storage medium having executable computer program instructions, the computer program instructions including: a geolocation module configured to identify a travel property based on location and movement of the mobile device; a planning module configured to predict a place based upon the travel property; and a string module configured to determine a plurality of strings based on the place, wherein each of the plurality of strings includes at least two places related through a relationship corresponding to the at least two places; wherein at least one of the plurality of strings is presented to the user on the mobile device as a possible travel plan.

In yet another aspect, a method of generating a travel-related string presentable to a user using a mobile device is described, the method comprising: determining a travel property based upon location and movement of a mobile device; associating at least one string with the travel property, the at least one string selected from a plurality of predetermined strings, wherein each of the plurality of predetermined strings, includes a first place, a second place, and a relationship; and providing the at least one of the plurality of predetermined strings to the user.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of an information system for use with a string based travel generating system (TGS) according to an embodiment of the present invention;

FIG. 2 is a block diagram of an TGS according to an embodiment of the present invention;

FIG. 3 is a schematic of a travel route with determined points of interest according to an embodiment of the present invention;

FIG. 4 is a schematic of a mobile device including strings according to an embodiment of the present invention;

FIG. 5 is a schematic of a mobile device according to an embodiment of the present invention;

FIG. 6 is a flow diagram of a method of generating strings having associated relationships based on travel properties according to an embodiment of the present invention; and

FIG. 7 is a schematic representation of a computer system suitable for use with the TGS according to an embodiment of the present invention.

### DETAILED DESCRIPTION

A string based travel generating system (TGS) of the present invention generates or suggests a string based upon one or more travel properties, such as, but not limited to, a current location, a direction of travel, a travel route, a travel plan, and/or a velocity of travel of a user. Each string includes at least two places and a relationship, with TGS using the travel properties to identify one or more places for the creation of a new string or a place that may be linked to an existing string. For example, TGS may identify a place as an anticipated destination of the user or may identify places en route to the anticipated destination. TGS may further develops strings by determining a relationship between the current location of the user and the identified place, between the identified place and the purpose of the trip, or between multiple identified places. TGS also may have the capability of using the travel properties to allow for the identification of previously created strings that include at least two places and a relationship, so as to allow for the re-creation of an authentic user experience. This authentic user experience is accomplished through the selection of two or more places intended to create an experience of a quality, character, and/or feel intended by the string author when the places are visited in temporal proximity to one another. The user experience may be further enhanced or guided through a narrative accompanying the string or places, written by the string author, that describes or invokes the quality, character or feel of the experience intended by the author. In certain embodiments, at least one of the places of the string may not have associated taxonomy or other place or related entity related information (e.g., business hours, description of services, etc.).

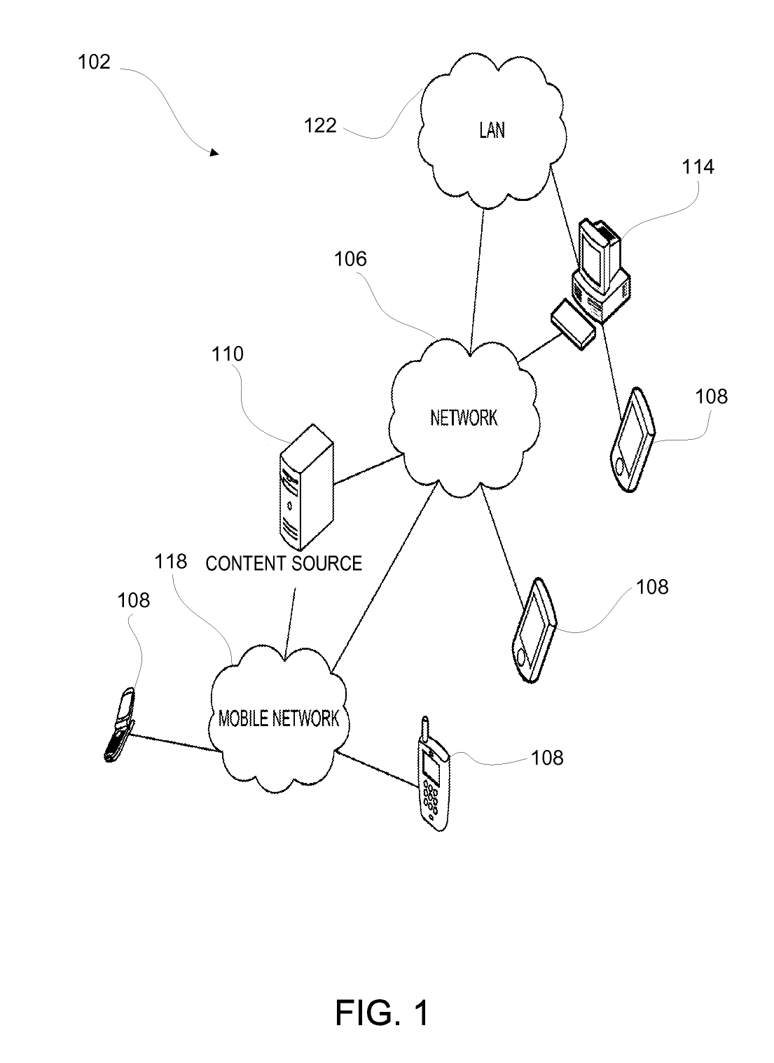

FIG. 1 illustrates an embodiment of a TGS 100 configured to identify, communicate, select, and otherwise interact with an information system 102. Information system 102 may be used to communicate a wide variety of content, information, and/or data between components of information system 102, the content or information including, but not limited to, user preferences, user situational factors, including time, date, weather, and user location, or other information and content that can influence the character and performance of a string.

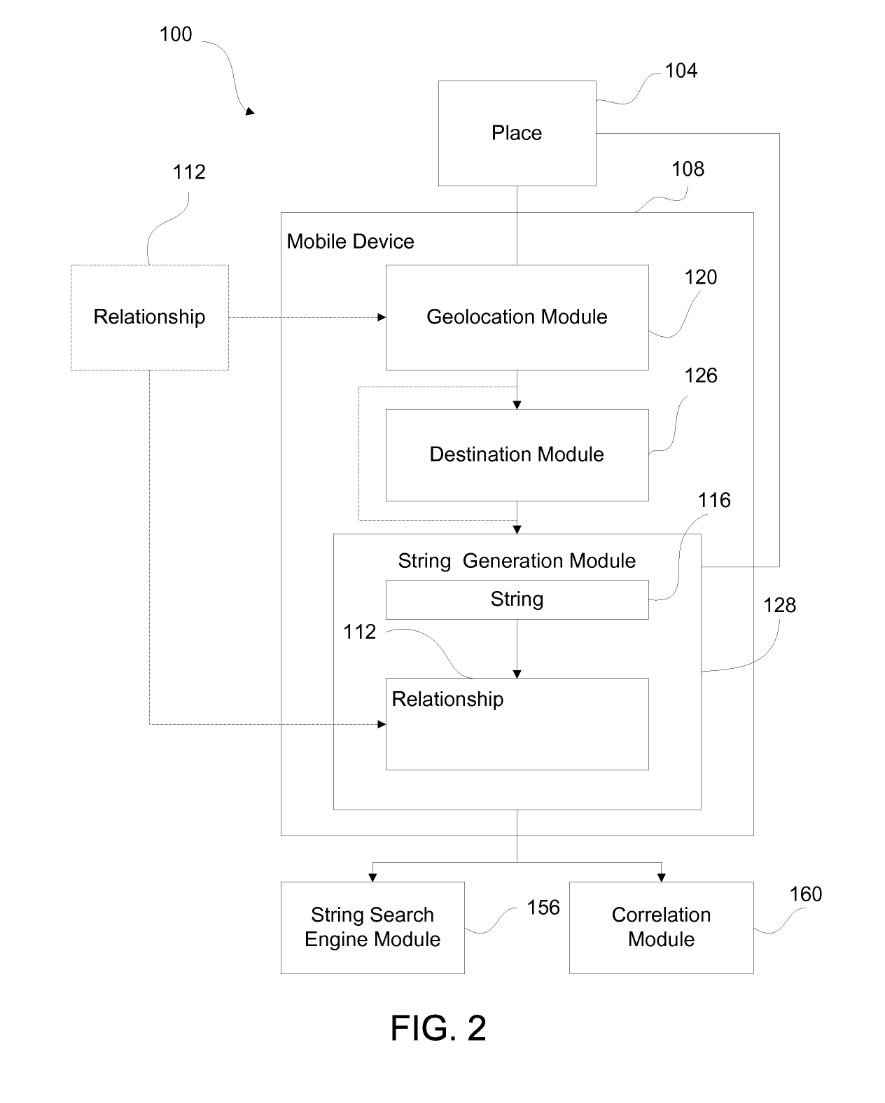

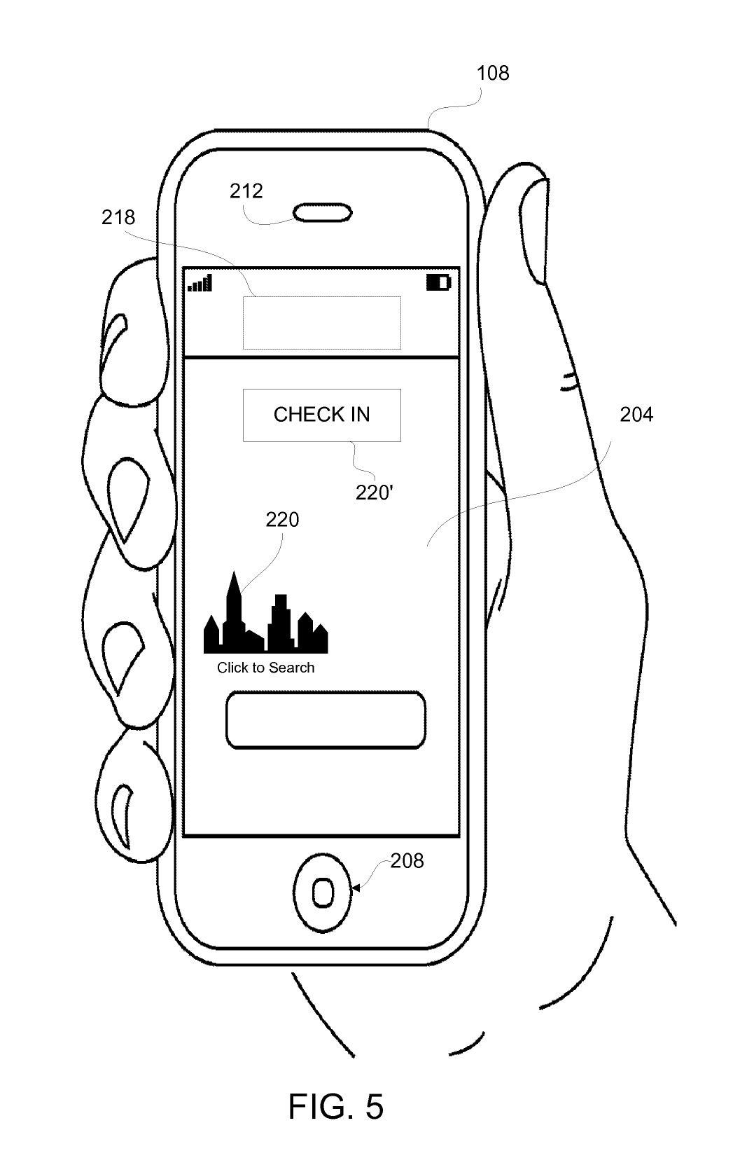

In an exemplary embodiment, information system 102 includes a network 106 and one or more mobile devices 108 or computing devices 114 that can include some or all of TGS 100. In an embodiment, mobile device 108 can be a device, such as, but not limited to, a smartphone, global positioning system (GPS) device, or may be a pad or a tablet computing device, a smart book, a net book, a laptop, and other devices with geolocation functionality that may be moved from one location to another without significant inconvenience. TGS 100 may be accessed on or interacted with through mobile device 108, by, for example, a user performing an overt action with respect to a user interface element (discussed further below with reference to FIG. 5) on the mobile device, such as touching an element or clicking on an element on the mobile device screen, so as to indicate that place 104 (FIG. 2) being selected is the location of the mobile device at the time the overt action is taken. Mobile device 108 may communicate with one or more components of information system 102, such as, but not limited to, other mobile devices 108, a content source 110, and one or more computing devices 114. Mobile device 108 may communicate to the aforementioned devices through network 106, mobile network 118, and/or local area network (LAN) 122, so as to access, record, store, or retrieve information, such as place, user, string, and/or or relationship information (discussed in detail below with reference to FIG. 2), in content source 110. Content source 110 can be, for example, a machine readable storage medium or a database, whether publicly accessible, privately accessible, or accessible through some other arrangement such as subscription, that holds, for example, information, data, programs, algorithms, or computer code, which is thereby accessible by mobile device 108.

As those skilled in the art will appreciate, computing device 114 may take a variety of forms, including, but not limited to, a server computer, a web appliance, a laptop computer, a desktop computer, a computer workstation, a terminal computer, web-enabled televisions, media players, and other computing devices in communication with network 106.

TGS 100 may also use an information system as discussed in U.S. Provisional Application No. 61/483,373, filed May 6, 2011, and titled “Geo-Location Based Playlist System and Method,” to Meyer, to communicate between modules included with the TGS. U.S. Provisional Application No. 61/483,373 is incorporated by reference for its discussion of the same. In an embodiment, communication between the modules included with TGS 100 (discussed in detail below with reference to FIG. 2) may be initiated through a webpage or application accessible on mobile device 108 or computing device 114. The website or application may be instantiated in a web-based environment existing on a web-page that is accessible through an information network, such as network 106. Mobile device 108 may also use the information network to facilitate communication between the mobile device and a content source, such as content source 110.

Turning now to FIG. 2, in an exemplary embodiment of TGS 100, TGS includes one or more software modules configured to develop and/or present one or more strings 116 to a user via a mobile device 108 using a geolocation module 124 in cooperation with a planning module 128 and a string generation module 132. Strings 116 are provided based upon a variety of factors including, but not limited to, the current location of mobile device 108, an anticipated destination, and/or the direction, route, or velocity of travel.

In an embodiment, geolocation module 124 is configured to determine a geolocation of mobile device 108. Geolocation module 124 can be configured to act upon the request of the user, via an input module (not shown), so as to identify and record the location of place 104, which in some embodiments may be a pair of coordinates (i.e., latitudinal and longitudinal) representative of the location of the user, the location of mobile device 108, an address of a business, an event location, a website address, or other addressable or geolocatable places. It should be appreciated by those of ordinary skill in the art that location information can be obtained in a number of different ways. For example, location information can be retrieved via global positioning system (GPS) technology. In another example, a user carrying mobile device 108 may be identified by a component of a mobile network (e.g., a location server, a presence server, a router, etc.) that mobile device 108 is connected to. In another example, triangulation techniques using multiple cell towers can be used to determine mobile device 108 location information. In yet another example, satellite locating techniques can be utilized to determine location information associated with mobile device 108.

Geolocation module 124 may also be configured to determine a direction of travel, velocity of travel, and, in certain embodiments, when used in connection with an internet based mapping program, such as, for example, Google Maps or Mapquest®, a route of travel of mobile device 108. Geolocation module 124 may detect changes in the location of mobile device 108 by triangulating a series of locations using mobile communication transmission stations, as is well known in the art. Also, a user may also select or designate the route, expected average velocity, and/or destination by ways known in the art, such as, but not limited to, touching a spot on a touch screen, voicing a command, directing a trackball, or using other devices in combination with a computer-based map program. For example, a user may designate the geolocatable place on the map program that is displayed on mobile device 108 by moving an indicator of the program to the location of the place on the map, and registering the geolocation by clicking a mouse button, voicing the appropriate command, pressing the touch screen, or otherwise so indicating that the location is the place of interest using techniques well known in the art.

In another exemplary embodiment, geolocation module 124 may use mobile device 108 to determine its location (as well as other travel-related factors) by using an address of an indicated place or ascertaining information associated with the indicated place. For example, mobile device 108 can become associated with an internet protocol (IP) address, a MAC address, a network port, or any number of other types of addressing or locating information. IP addresses, MAC addresses, and others may be analyzed to ascertain information about the location of the mobile device 108. Alternatively, mobile device 108 can utilize an address associated with an internet service provider, a local area network, and the like.

In another embodiment, geolocation module 124 can be configured to identify characteristics of an intangible place being accessed by a user using for example, mobile device 108 or computing device 114. Intangible places can be places such as, but not limited to, a web page, a page in an electronic book, or virtual coordinates. Geolocation module 124 may indicate characteristics as appropriate for the intangible place, such as, the web address of the page, webpage content, webpage theme, book genre, etc. For the purposes of this disclosure, the characteristics of intangible places will be encompassed within the term geolocation, along with its customary meaning as used herein.

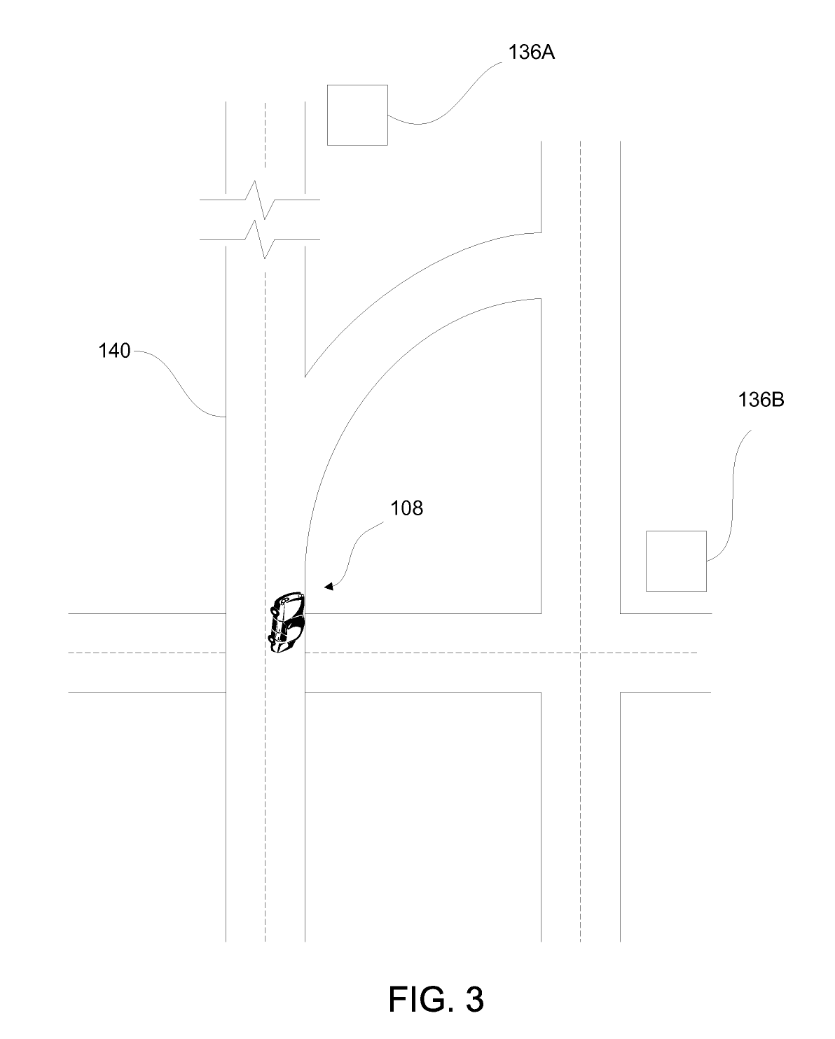

Planning module 128 receives as input a geolocation and other travel properties from geolocation module 124 and is configured to identify one or more possible travel plans 134 and/or destinations 136 (FIG. 3) for the user. Travel plans 134 are typically, although not necessarily, strings 116 that are identified as having a characteristic or relationship 112 in common with the travel properties identified by geolocation module 124. For example, if geolocation module 124 determines that the user may be on vacation because of the velocity and length of the user's present travel, planning module 128 may determine suitable strings that have a vacation theme and that are located proximate the user's course of travel. As a specific example, where a user has entered in user information, such as the fact that they have school age children and the user has travel properties that indicate a vacation is underway, planning module 128 may indicate to the user the location of a string 116 that includes a theme park, a family friendly restaurant, and a science museum that all reside only a short distance from a presumed extension of the route of travel. As another example, if the user is traveling during the evening hours and is traveling to a theater district, planning module 128 may propose a string 116 including fashionable diner, a listing of the current theater productions at a popular theater, and a place for a late night cocktail.

Planning module 128 may also determine virtual strings 116 associated with a users web searching. Similar to what was discussed above with reference to geolocation module 124, a user's search history on the internet including the types of places visited and other attributes to the intangible places visited by the user, are virtual travel properties. Planning module 124 may use these virtual travel properties in much the same way that it uses the “real” travel properties discussed above. For example, if the user has been reviewing a number of websites related to a certain musical group, planning module 124 can determine what relationship the musical group has to strings 116 in content provider 110. Planning module 124 may then suggest, for example, a string 116 that includes a tour of popular fan sites of the musical group as well as places to purchase the music and to learn about the history of the musicians.

Planning module 128 may also take into account a destination 136 if known or determinable. In one embodiment, and as shown in FIG. 3, planning module identifies possible destinations 136A and 136B by, for example, noting the current location of mobile device 108 and the route of travel of the device, and from that information, extrapolating destination 136. For example, if mobile device 108 is traveling along an interstate 140 terminating at a population center, planning module 128 may identify the population center as anticipated destination 136A. Planning module 128 may also identify a particularly popular retail outlet as anticipated destination 136B. In yet another example, planning module 128 can communicate with content source 110 through information network 106 in order to determine stored user preferences, travel histories or a history of route queries associated with the user in order to further inform the determination of anticipated destination 136. Similarly, planning module 128 can communicate with content source 110 through information network 106 to determine travel histories and route queries associated with other users in the same geographic region as mobile device 108 so as to inform the determination of anticipated destination 136.

As noted above, planning module 128 may also attempt to determine the type or character of the trip being endeavored by the user of mobile device 108 or computing device 114 so as to inform the choice of anticipated destination 136. For example, planning module 128 may infer whether the travel is for business, vacation, a daily commute, household errands, or if it is a virtual trip, what the trip is for, e.g., shopping, research, education, or news. Factors used to determine the type or character of the travel may include, in addition to the factors previously disclosed, traffic conditions, duration and frequency of travel stops, time of year, day of week, time of day, user age, user preferences, or express indication of the type of travel made by the user of mobile device 108. For intangible travel, factors may include time spent on a site, site content, consistency between sites, or an express indication of the type of travel made by the user. Those skilled in the art will appreciate that other factors can be used to infer the type or character of the travel.

Once the type of travel is determined, this information can be used to further inform the determination of anticipated destination 136 and/or a plan 134. For example, if the type of travel is determined to be a weekend-long vacation, anticipated destinations can then include population centers (e.g., anticipated destination 136A (FIG. 3)) or places within, for example, less than an 8 hour travel duration. Upon reading this description, those skilled in the art will appreciate planning module 128 will function as described regardless of the type of plan 134, anticipated destination 136, or the nature of travel. The anticipated destinations 136 or travel plans 134 identified by planning module 128 may then be provided to string generation module 132.

String generation module 132 may use as inputs the information previously described in the context of geolocation module 124 (e.g., a geolocation, a direction of travel, a route, a velocity of travel, etc.) and planning module 128 (e.g., one or more anticipated destinations 136) in order to create one or more strings. Strings 116 may be understood to include two or more places, including intangible places such as website addresses, eBook pages, or coordinates in a virtual world (e.g., Second Life®environments), that are related by a relationship 112. Further discussions on the creation of strings are presented in Applicants' pending U.S. patent application, Ser. No. 13/274,068, which is incorporated by reference for its discussion of the same.

Relationship 112 may include a theme, a narrative, or a trait that is common to places 104 of string 116 or otherwise unites the places so as to produce a cohesive user experience. Some factors that can be used to establish relationship 112 between places 104 of string 116 include, but are not limited to, geolocations of each place, the temporal proximity between places, the timeframe associated with the string (total time to visit/access all places in the string), the window of time within which each place must or should be visited, costs associated with each place or with performance of a string in its entirety, a correlation as described in more detail elsewhere within the present disclosure, and/or the narrative supplied with the string that provides a description of the string experience. For example, temporal proximity of places 104 may be a component used to create a quality or type of experience intended by the author of string 116. In another example, temporal proximity can be used to establish relationship 112 between places 104 in the event that one of the places is accessible to users only within a defined period of time. Relationships 112 can further be determined by categorizing traits of places 104 and strings 116 using a taxonomy system or a folksonomy system, as described in Applicants' U.S. patent application, Ser. No. 13/274,068, which is incorporated herein by reference for its discussion of the same.

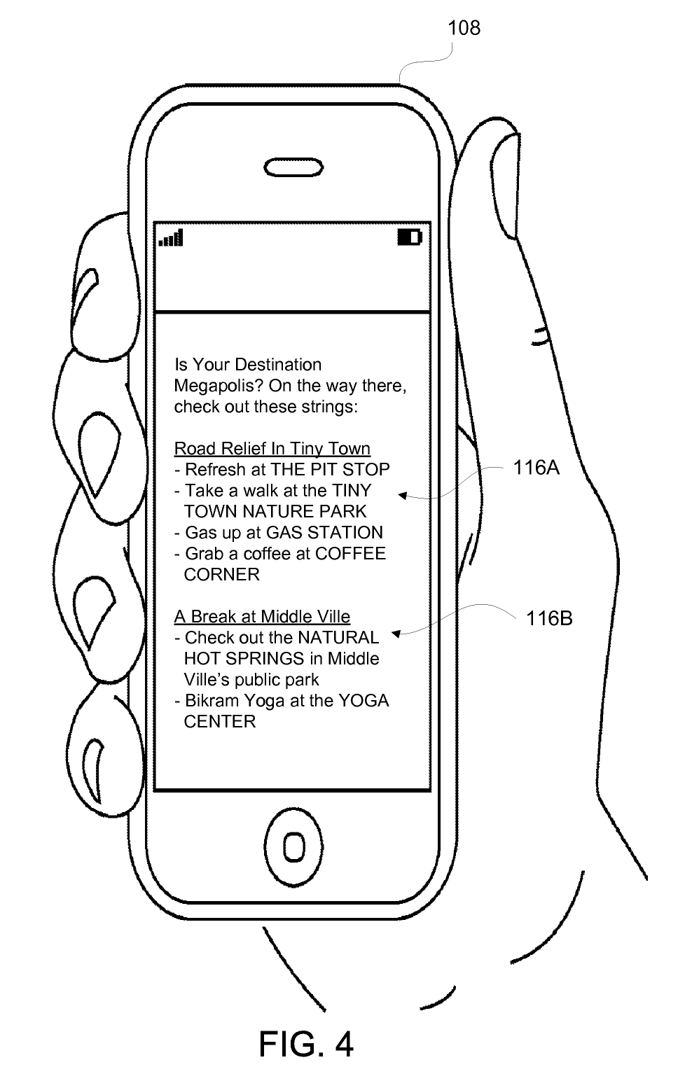

As illustrated in FIG. 4, string generation module 132 may provide multiple strings 116, such as strings 116A and 116B, as the user travels to, for example, anticipated destination 136A, on mobile device 108. For example, if the anticipated destination is population center 136A, strings 116A and 116B can be provided by string generation module 132 to provide a welcome respite for the traveler. In one embodiment of this example, string 116A includes travel-related places 104 (e.g., a gas station), as well as non-travel related places (e.g., a walk in the town park). Other strings 116 can include, for example, a roadside attraction, a historical event marker, and a meal location so that a traveler is entertained and refreshed, but not unduly delayed. String 116B may be provided as an alternative string en route to anticipated destination 136A. In other embodiments, string 116 may be provided at anticipated destination 136A and include a dinner location, a bar, and a hotel that will end the day of travel. Those skilled in the art will appreciate the variety of strings 116 that may be provided by string generation module 132 in cooperation with geolocation module 124 and planning module 128, either at the anticipated destination or en route, that may meet a wide variety destinations, routes, and user preferences.

The types of strings 116 provided to a user may be tailored according to the type of travel, as described above and determined by planning module 128. For example, upon planning module 128 inferring that the travel is business related, string generation module 132 may provide one or more strings 116 that include places 104 associated with business travel. These places 104 include, but are not limited to, business-friendly lunch and dinner venues, providers of business services (e.g., copying, stenography, notarizing, etc.), hotels catering to business travelers, dry cleaners, etc. In another example, upon planning module 128 determining that the travel is related to household errands, string generation module 132 may provide strings 116 having places 104 such as grocers, hardware stores, home furnishing stores, etc. String generation module 132 may also provide options that complement the travel type. For example, a coffee shop may be supplied as part of the household errands string described above in order to provide relief from an otherwise long list of chores. Upon reading this disclosure, those skilled in the art will appreciate the variety of strings and places that can be provided, consistent with a string theme, as described in U.S. Provisional Patent Application Ser. No. 61/483,373, and incorporated by reference herein.

Returning to FIG. 2, TGS 100 may also include a string search engine 156. String search engine 156 facilitates the searching of existing strings 116 located in, for example, content source 110 or other database. String search engine 156 may be configured to allow for searching of strings 116 using a variety of different criteria including, but not limited to express or inferred travel destination, express or inferred travel purpose, geolocation, anticipated destination, user preferences, and others. For example, string search engine 156 may search existing strings 116 by string author. In another example, string search engine 156 may search existing strings 116 by place 104. In yet another example, string search engine 156 may search existing strings 116 by proximity to a desired location, for instance, if a searcher would like to view all of the strings located near a certain location or destination, e.g., Boston, Mass., Stowe, Vt., etc. In this example, string search engine 156 would return all strings 116 in the locale designated by the searcher. In yet a further example, string search engine 156 may allow a search by places 104 associated with a string 116. In this example, a place of interest would be input into string search engine 156 and the string search engine would return all of those strings 116 that included the place of interest. Furthermore, string search engine 156 may search using any combination of the foregoing criteria. Further discussion of string search engine 156 is discussed in Applicants' pending U.S. application Ser. No. 13/274,051, which is incorporated by reference for its discussion of the same.

TGS 100 may also include a correlation module 160. Correlation module 160 assists in determining various relationships between one or more places 104 designated by a user. In an embodiment of correlation module 160, the correlation module can determine, based upon strings 116, a frequency of occurrence of a sequence of places 104 across multiple strings. The frequency of occurrence can indicate a strong or preferred relationship between two or more places 104. The details of the correlation between places 104 is described in more detail in Applicants' U.S. patent application, Ser. No. 13/274,068, and incorporated by reference herein.

FIG. 5 shows an implementation of a mobile device 108 suitable for use with TGS 100. Mobile device 108 can include a touch-sensitive display 204, an input device 208, a speaker 212, and a transceiver 218. Touch-sensitive display 204 is sometimes called a “touch screen” for convenience, and may also be known as or called a touch-sensitive display system. Touch screen 204 can be used to display information or to provide user-interface objects 220 (e.g., virtual (also called “soft”) control keys, such as buttons or keyboards), thereby providing an input interface and an output interface between mobile device 108 and a user. Information displayed by touch screen 204 can include graphics, maps, text, icons, video, and any combination thereof (collectively termed “graphics”). In an embodiment, and in use with TGS 100, a user can select one or more user-interface objects 220, e.g., object 220′, using touch screen 204 to designate that mobile device 108 is at a present location.

Touch screen 204 has a touch-sensitive surface, which uses a sensor or set of sensors to accept input from the user based on haptic and/or tactile contact. Touch screen 204 may use LCD (liquid crystal display) technology, or LPD (light emitting polymer display) technology, although other display technologies may be used in other embodiments. Touch screen 204 can detect contact (and any movement or breaking of the contact) on the touch screen and converts the detected contact into interaction with user-interface objects (e.g., one or more soft keys, icons, web pages or images) that are displayed on the touch screen. Touch screen 204 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 204. In an exemplary embodiment of the use of mobile device 108, a user presses a finger to touch screen 204 so as to initiate contact. In alternative embodiments, a user may make contact with touch screen 204 using any suitable object, such as, but not limited to, a stylus.

Input device 208 facilitates navigation among and interact with one or more user-interface objects 220 displayed in the touch screen 204. In an embodiment, input device 208 is a click wheel that can be rotated or moved such that it can be used to select one or more user-interface objects 220 displayed on touch screen 204. In an alternative embodiment, input device 208 can be a virtual click wheel, which may be either an opaque or semitransparent object that appears and disappears on the touch screen display in response to user interaction with mobile device 108.

Transceiver 218 receives and sends signals from mobile device 108. In an embodiment of mobile device 108, transceiver 218 sends and receives radio frequency signals through one or more communications networks, such as network 106 (FIG. 1), and/or other computing devices, such as computing device 114. Transceiver 218 may be combined with well-known circuitry for performing these functions, including, but not limited to, an antenna system, one or more amplifiers, a tuner, one or more oscillators, a digital signal processor, a CODEC chipset, a subscriber identity module (SIM) card, and a memory. As mentioned above, transceiver 218 may communicate with one or more networks, such as the Internet, also referred to as the World Wide Web (WWW), an intranet and/or a wireless network, such as a cellular telephone network, a wireless local area network (LAN), and/or a metropolitan area network (MAN), and other devices. Mobile device 108 may use any of a plurality of communications standards to communicate to networks or other devices with transceiver 218. Communications standards, protocols and technologies for communicating include, but are not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol.

Transceiver 218 may also be configured to assist mobile device 108 in determining its current location. For example, geolocation module 124 (FIG. 2) can provide signals to transceiver 218 that are suitable for determining the location of mobile device 108, as discussed in detail above.

Mobile device 108 may also include other applications or programs such as, but not limited to, word processing applications, JAVA-enabled applications, encryption, digital rights management, voice recognition, voice replication, and a browser module. The browser module may be used to browse the Internet, including searching, linking to, receiving, and displaying web pages or portions thereof, as well as attachments and other files linked to web pages.

It should be appreciated that the mobile device 108 is only one example of the mobile device that may be used with the present system and method, and that the mobile device may have more or fewer components than mentioned, may combine two or more components, or a may have a different configuration or arrangement of the components. In the present system and method, mobile device 108 may be implemented with any computing device that includes geolocation functionality and is not so large that it is very inconvenient to move it from one location to another. Thus, mobile device 108 is not restricted to a smartphone or other hand-held device, and may include pad or tablet computing devices, smart books, net books, laptops, and even larger computing devices with geolocation functionality that may be moved from one location to another without significant inconvenience.

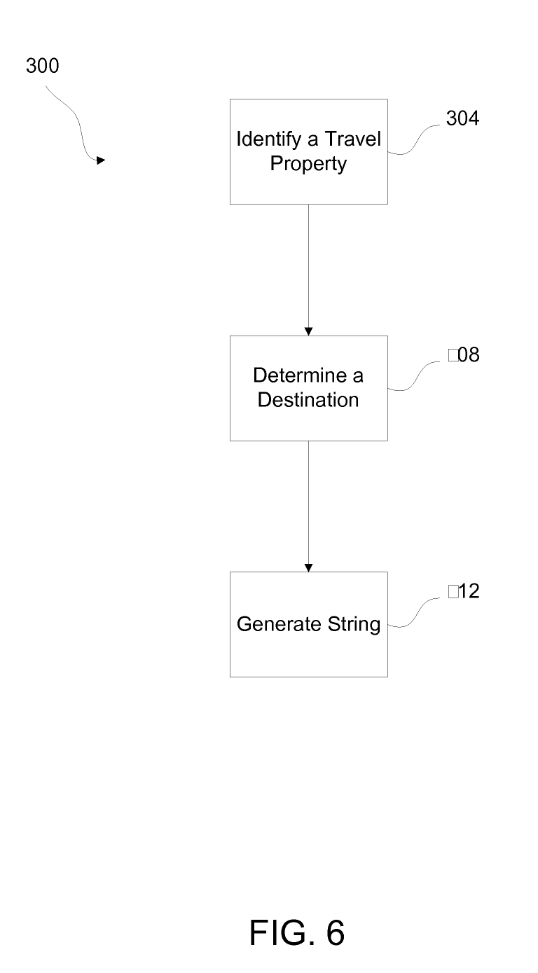

Turning now to FIG. 6, there is shown an exemplary process 300 for generating a string, such as a string 116. At step 304, a travel property is identified. Travel properties typically include a current location of a user or device, such as a mobile device 108, and properties related to the travels of the user. For example, if the user is moving, by car, bus, train, bike, etc., properties such as in which direction the user is travelling, how fast is the user travelling, and what routes is the user currently on, can be identified. If the user is not moving, but instead is, for example, visiting places on the internet, the identification of travel properties may include the web address for the page visited, the genre or type of page visited (e.g., informational, shopping, reference, travel, etc.), length of time on the web page, recent searches, etc.

At step 308 at least one destination is determined. The destination may be a final destination of the user or may be a way station for the user along his/her path of travel. The type of destination may be predicted based upon the physical travel properties developed above and may include other factors such as, but not limited to, the time of day, a projected or stated purpose of travel, or a window for travel. If the destination is virtual, the destination may be determined based upon, for example, past user web page history, current virtual page content, user preferences, search history, and the like.

The destination(s) determined from step 308 are used to develop at least one string in step 312. The strings may be new strings based upon the current location and the anticipated destination or possible destinations, or may be already existing strings that are sufficiently correlated to one or more of the anticipated destinations. Newly created strings include one or more destinations determined in step 308 and a relationship derived from characteristics of the destinations. For virtual strings, the strings would include virtual places and experiences that a person can use. All strings include a relationship, which may be ascertained from characteristics of the places or may have been previously submitted by an author.

It is to be noted that any one or more of the aspects and embodiments of process 300 and/or TGS 100, as described herein, may be conveniently implemented using one or more machines (e.g., one or more computing devices that are utilized as a user computing device) programmed according to the teachings of the present specification, as will be apparent to those of ordinary skill in the computer art. Aspects and implementations of TGS 100, discussed above, employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device, mobile device 108) or a portion of the machine and that causes the machine to perform any one of the methodologies and/or embodiments described herein. Examples of a machine-readable storage medium include, but are not limited to, a magnetic disk, an optical disk, a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine and any related information (e.g., data structures and data) that causes the machine to perform any one of the methodologies and/or embodiments described herein.

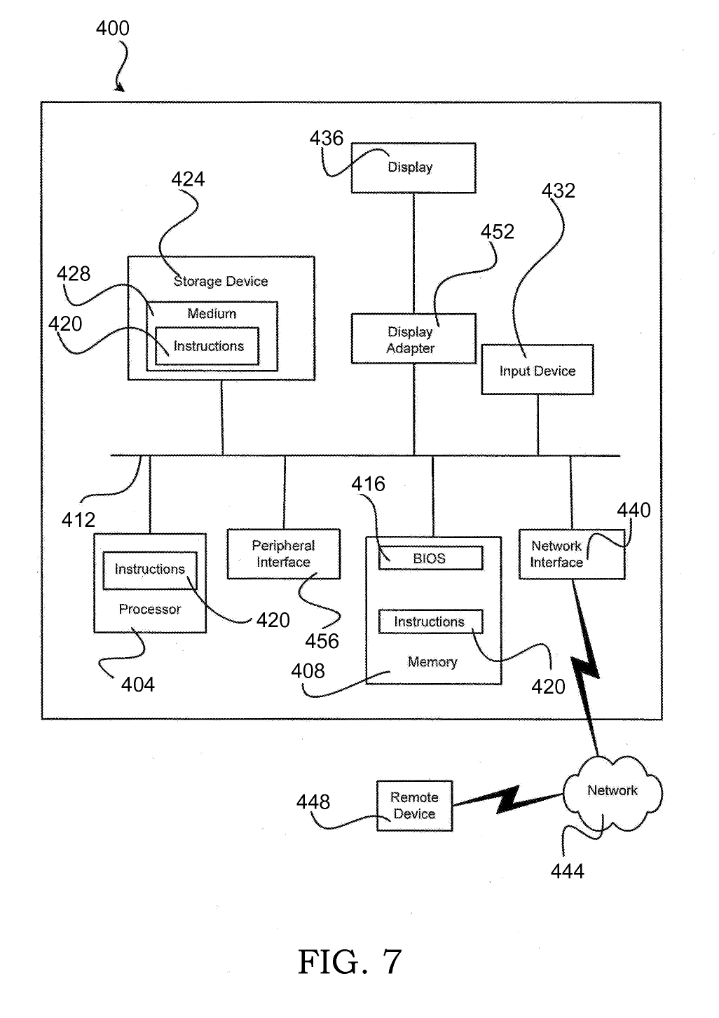

FIG. 7 shows a diagrammatic representation of one embodiment of control system 112 in the exemplary form of a system 400, e.g., computing device 114 or mobile device 108, within which a set of instructions for causing a processor 404 to perform any one or more of the aspects and/or methodologies, such as process 300, of the present disclosure. It is also contemplated that multiple computing devices, such as computing device 114, or mobile devices 108, or combinations of computing devices and mobile devices, may be utilized to implement a specially configured set of instructions for causing TGS 100 to perform any one or more of the aspects and/or methodologies of the present disclosure.

System 400 can also include a memory 408 that communicate with each other, and with other components, via a bus 412. Bus 412 may include any of several types of bus structures including, but not limited to, a memory bus, a memory controller, a peripheral bus, a local bus, and any combinations thereof, using any of a variety of bus architectures.

Memory 408 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 416 (BIOS), including basic routines that help to transfer information between elements within system 400, such as during start-up, may be stored in memory 408. Memory 408 may also include (e.g., stored on one or more machine-readable media) instructions (e.g., software) 420 embodying any one or more of the aspects and/or methodologies of the present disclosure. In another example, memory 408 may further include any number of program modules including, but not limited to, an operating system, one or more application programs, other program modules, program data, and any combinations thereof.

System 400 may also include a storage device 424, such as, but not limited to, the machine readable storage medium described above. Storage device 424 may be connected to bus 412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 424 (or one or more components thereof) may be removably interfaced with system 400 (e.g., via an external port connector (not shown)). Particularly, storage device 424 and an associated machine-readable medium 428 may provide nonvolatile and/or volatile storage of machine-readable instructions, data structures, program modules, and/or other data for system 400. In one example, software 420 may reside, completely or partially, within machine-readable medium 428. In another example, software 420 may reside, completely or partially, within processor 404.

System 400 may also include an input device 432. In one example, a user of system 400 may enter commands and/or other information into system 400, for example using input device 208, via input device 432. Examples of an input device 432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 432 may be interfaced to bus 412 via any of a variety of interfaces (not shown) including, but not limited to, a serial interface, a parallel interface, a game port, a USB interface, a FIREWIRE interface, a direct interface to bus 412, and any combinations thereof. Input device 432 may include a touch screen interface that may be a part of or separate from display 436, discussed further below. Input device 432 may be utilized as a user selection device for selecting one or more graphical representations in a graphical interface as described above.

A user may also input commands and/or other information to system 400 via storage device 424 (e.g., a removable disk drive, a flash drive, etc.) and/or network interface device 440. A network interface device, such as network interface device 440 may be utilized for connecting system 400 to one or more of a variety of networks, such as network 444, and one or more remote devices 448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 444, may employ a wired and/or a wireless mode of communication. In general, any network topology may be used. Information (e.g., data, software 420, etc.) may be communicated to and/or from system 400 via network interface device 440.

System 400 may further include a video display adapter 452 for communicating a displayable image to a display device, such as display device 436. Examples of a display device include, but are not limited to, a liquid crystal display (LCD), a cathode ray tube (CRT), a plasma display, a light emitting diode (LED) display, and any combinations thereof. In addition to a display device, a system 400 may include one or more other peripheral output devices including, but not limited to, an audio speaker, a printer, and any combinations thereof. Such peripheral output devices may be connected to bus 412 via a peripheral interface 456. Examples of a peripheral interface include, but are not limited to, a serial port, a USB connection, a FIREWIRE connection, a parallel connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A travel generating system for use with a mobile device, comprising:
a computer-readable storage medium having executable computer program instructions including:
a geolocation module configured to identify a travel property;
a planning module configured to receive said travel property, wherein said planning module determines a travel plan for the mobile device based on said travel property, wherein said travel plan includes a string having at least two places related through relationship.

2. A travel generating system according to claim 1, further including a string module configured to generate said string based upon said travel property and a destination determined by said planning module.

3. A travel generating system according to claim 2, wherein said string module additionally determines said string based on a trip purpose.

4. A travel generating system according to claim 3, wherein the trip purpose includes a leisure trip.

5. A travel generating system according to claim 3, wherein the trip purpose includes a business trip.

6. A travel generating system according to claim 1, wherein said travel property includes at least one of a direction, a route, and a velocity of travel of the mobile device.

7. A travel generating system according to claim 1, wherein said string includes a location en route to an anticipated destination.

8. A travel generating system according to claim 1, wherein at least one place lacks related entity information.

9. A travel generating system according to claim 1, wherein said relationship includes the trip purpose.

10. A travel generating system according to claim 9, wherein said planning module infers a trip purpose based on one or more of a direction, a route, and a velocity of travel of the mobile device.

11. A string generating system for predicting a destination of a user while traveling and generating a travel plan related to the prediction, the string generating system comprising:
a mobile device including a computer-readable storage medium having executable computer program instructions, the computer program instructions including:
a geolocation module configured to identify a travel property based on location and movement of said mobile device;
a planning module configured to predict a place based upon said travel property; and
a string module configured to determine a plurality of strings based on said place, wherein each of said plurality of strings includes at least two places related through a relationship corresponding to said at least two places;
wherein at least one of said plurality of strings is presented to the user on said mobile device as a possible travel plan.

12. A system according to claim 11, wherein said geolocation module is further configured to permit a user to select coordinates using a computer executable mapping program.

13. A system according to claim 11, wherein at least one of said plurality of strings includes an intangible place.

14. A system according to claim 13, wherein said intangible place includes an internet address.

15. A system according to claim 13, wherein said intangible place includes a coordinate in a virtual space.

16. A system according to claim 13, wherein said intangible place includes an address of a page of an electronic book.

17. A system according to claim 11, wherein each of said relationships includes visiting a first place within a first window and visiting a second place within a second window, wherein said first window and said second window define a time frame and are selected to create an authentic user experience.

18. A system according to claim 17, wherein said travel plan is performed within said time frame.

19. A system according to claim 17, wherein said relationship includes a user provided narrative describing a connection between said first place and said second place.

20. A method of generating a travel-related string presentable to a user using a mobile device, the method comprising:
determining a travel property based upon location and movement of a mobile device;
associating at least one string with the travel property, the at least one string selected from a plurality of predetermined strings, wherein each of the plurality of predetermined strings, includes a first place, a second place, and a relationship; and
providing the at least one of said plurality of predetermined strings to the user.

21. A method according to claim 20, wherein said associating includes determining a distance between the mobile device and said first place or said second place.

22. A method according to claim 20, wherein the second place does not have related entity information.

23. A method according to claim 20, wherein the travel property is selected from the list of geolocation, a direction, a velocity, and a route of travel.

24. A method according to claim 20, wherein the at least one string includes an address of an intangible place.

25. A method according to claim 21, wherein the address of the intangible place includes an internet address.
